(19) United States
(12) Patent Application Publication
(10) Pub. No.: US 2011/0013348 A1
(43) Pub. Date: Jan. 20, 2011

(54) Apparatus and Method for Power Distribution to and Cooling of Computer Components on Trays in a Cabinet

(76) Inventors: Lawrence B. Seibold, San Jose, CA (US); Giovanni Coglitore, Saratoga, CA (US); Robert M. Kinstle, III, Milpitas, CA (US)

Correspondence Address: COOLEY LLP;ATTN: Patent Group, Suite 1100, 777 - 6th Street, NW, WASHINGTON, DC, 20001, US

(21) Appl. No.: 12/726,301

(22) Filed: Mar. 17, 2010

Related U.S. Application Data
(60) Provisional application No. 61/161,033, filed on Mar. 17, 2009.

(51) Int. Cl. G06F 1/16

(52) U.S. Cl. 361/679.02

(57) ABSTRACT

A computer system includes a cabinet, a plurality of trays located in the cabinet and having a plurality of computer components mounted thereon, a first port mounted on a rear panel of the cabinet that receives a three-phase AC input to the cabinet, a power distribution unit that converts the three-phase AC input to a plurality of AC signals each having fewer than three phases, a plurality of rectifiers, and a power distribution bus. The plurality of rectifiers convert the plurality of AC signals to DC power. The power distribution bus distributes the DC power. Each of the plurality of rectifiers is coupled to the power distribution bus. The tray receives the DC power from the power distribution bus.

### CROSS-REFERENCE TO RELATED APPLICATIONS

This application claims the benefit of U.S. provisional patent application No. 61/161,033, entitled “APPARATUS AND METHOD FOR POWER DISTRIBUTION TO AND COOLING OF COMPUTER COMPONENTS ON TRAYS IN A CABINET” filed on Mar. 17, 2009, which is incorporated herein by reference in its entirety.

### FIELD OF THE INVENTION

The present invention relates generally to the manner in which computer components are designed, configured, and installed in a given area. More particularly, this invention relates to power distribution to and cooling of computer components mounted on trays in a cabinet.

### BACKGROUND OF THE INVENTION

As information technology has rapidly progressed, computer network centers such as server farms and server clusters have become increasingly important to our society. The server farms provide efficient data processing, storage, and distribution capability that supports a worldwide information infrastructure, which has come to alter how we live and how we conduct our day to day business.

At a site where numerous computers are connected to a network, the computers and related equipment are often stacked in racks. Many of the racks are filled with cumbersome computers mounted on sliders, which are attached through mounting holes provided in the front and back of the rack. Each of these computers is often also housed in a chassis. It can be inconvenient to service and/or upgrade components of these computers because a computer may need to be dismounted from a rack, and a portion of the chassis housing the computer may need to be disassembled. In addition, to service and/or upgrade a component of these computers, the entire computer may need to be taken out of service.

Moreover, the form factor of computers is becoming progressively smaller. For example, for computer chassis with a 1U height (1.75″), approximately 1U-sized fans are typically installed inside the chassis. As compared to larger fans typically used in chassis housing computers with larger form factors, these small fans may be mechanically unreliable and may also have significantly less air moving ability, which may impact both the maintainability and cooling of computers with a small form factor.

In view of the foregoing problems, it would be desirable to provide techniques for power distribution to and cooling of computer components mounted on trays in a cabinet.

### SUMMARY OF THE INVENTION

In one innovative aspect, the invention relates to a computer system comprising a cabinet, a plurality of trays located in the cabinet and having a plurality of computer components mounted thereon, a first port mounted on a rear panel of the cabinet that receives a three-phase AC input to the cabinet, a power distribution unit that converts the three-phase AC input to a plurality of AC signals each having fewer than three phases, a plurality of rectifiers, and a power distribution bus. The plurality of rectifiers convert the plurality of AC signals to DC power. The power distribution bus distributes the DC power. Each of the plurality of rectifiers is coupled to the power distribution bus. The tray receives the DC power from the power distribution bus.

In another innovative aspect, the invention relates to a computer system comprising a cabinet, a first plurality of trays located in an upper portion of the cabinet and having a first plurality of computer components mounted thereon, a second plurality of trays located in a lower portion of the cabinet and having a second plurality of computer components mounted thereon, a first AC-to-DC power conversion module, a second AC-to-DC power conversion module, a first DC power distribution bar coupling the first AC-to-DC power conversion module to the first plurality of trays, and a second DC power distribution bar coupling the second AC-to-DC power conversion module to the second plurality of trays. The first AC-to-DC power conversion module is mounted on the upper portion of the cabinet, and is positioned above at least one of the first plurality of trays and below at least one of the first plurality of trays to reduce the distance over which a DC voltage output of the first AC-to-DC power conversion module is distributed to the first plurality of trays. The second AC-to-DC power conversion module is mounted on the lower portion of the cabinet, and is positioned above at least one of the second plurality of trays and below at least one of the second plurality of trays to reduce the distance over which a DC voltage output of the second AC-to-DC power conversion module is distributed to the second plurality of trays. The first plurality of trays receives DC power from the first DC power distribution bar, and the second plurality of trays receives DC power from the second DC power distribution bar.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a front perspective view of a computer system including a cabinet and trays mounted in the cabinet, in accordance with one embodiment of the present invention;

FIG. 2 illustrates a top perspective view of a tray including computer components mounted thereon, in accordance with one embodiment of the present invention;

FIG. 3 illustrates a rear perspective view of a computer system, in accordance with one embodiment of the present invention;

FIG. 4 illustrates a cutaway side view of a computer system showing a plenum between the back of trays in a cabinet and a rear panel of the cabinet with representative airflow paths, in accordance with one embodiment of the present invention; and

FIG. 5 illustrates a circuit for converting a three-phase AC input to DC outputs provided to trays, in accordance with one embodiment of the present invention.

### DETAILED DESCRIPTION OF THE INVENTION

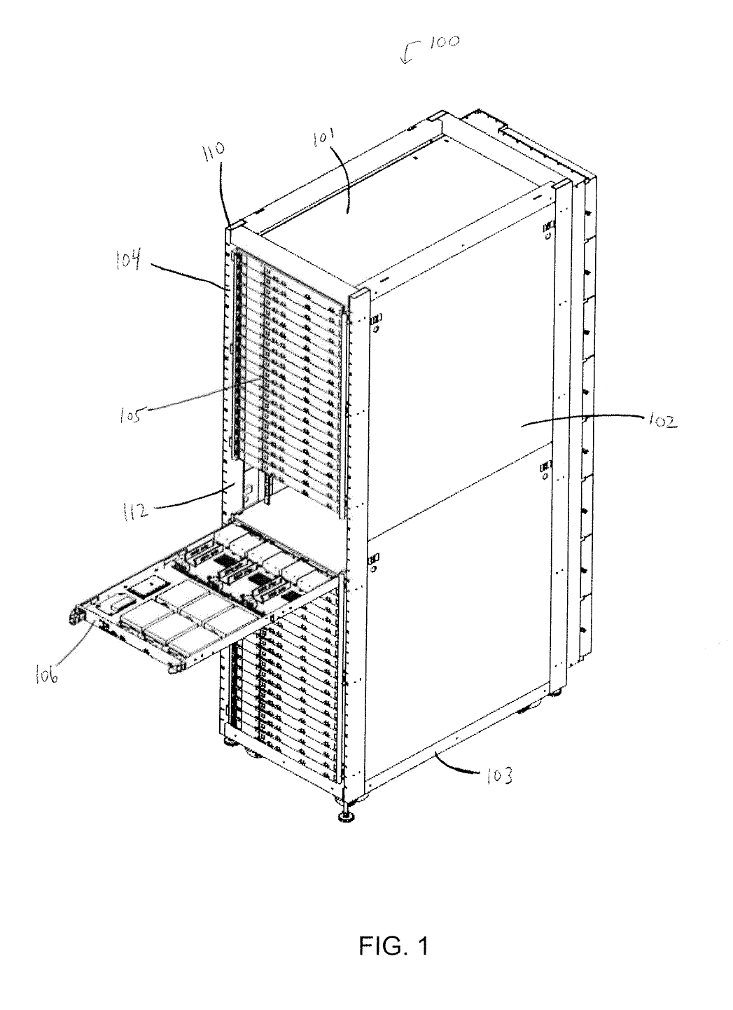

FIG. 1 illustrates a front perspective view of a computer system 100 including a cabinet 110 and trays 105 mounted in the cabinet 110, in accordance with one embodiment of the present invention. The cabinet 110 has a top panel 101, side panels 102, and a bottom panel 103. Trays 105 have front panels 106 that face outward from a front side 104 of the cabinet 110. The front side 104 of the cabinet 110 may at least partially expose front panels 106 of trays 105. In one embodiment, the front side 104 of the cabinet 110 may not be covered with a front panel to facilitate access to the trays 105, such as for servicing or replacement of the trays 105. The exposure of the front panels 106 also enhances airflow from outside the cabinet 110 toward the front panels 106 of the trays 105, or the reverse, for cooling computer components mounted on the trays 105. Alternatively, the front side 104 of the cabinet 110 may be covered with a front panel (not shown). The front panel may be used to reduce electromagnetic interference (EMI) from the cabinet 110. The front panel may also allow air to flow from outside the cabinet 110 through the front panel toward the front panels 106 of the trays 105, or the reverse. Computer components may be mounted on the trays 105. The trays 105 may be horizontally mounted in the cabinet 110, as shown in FIG. 1. Alternatively, the trays 105 may be vertically mounted in the cabinet 110. If vertically mounted, the trays 105 may be mounted in one or more vertically spaced apart bays (not shown). The trays 105 may be mounted on rails attached to side panel 102 such that the rails face trays 105 mounted in the cabinet 110, to allow the trays 105 to slide in and out of the cabinet 110. In FIG. 1, tray 105A has been slid out of the cabinet 110.

In one embodiment, the cabinet 110 may have a portion 112 that may be designed for mounting equipment other than trays 105, such as an off-the-shelf switch fabric (not shown). The portion 112 may also be designed for mounting additional trays 105.

In one embodiment, the cabinet 110 may have a height that is an integer multiple of 1U. Some examples of commonly used cabinet heights are 22U, 23U, 36U, 40U, 42U, 44U, and 46U. Each tray 105 may also have a height that is an integer multiple of 1U, such as 1U or 2U. Alternatively, each tray 105 may have a height that is not an integer multiple of 1U, such as 0.5U or 1.5U. The cabinet 110 may also have a height that is not an integer multiple of 1U, such as 43.5U or 44.5U. In one representative embodiment, the cabinet 110 may have a width of approximately 24″ and a depth of approximately 40″. Trays 105 horizontally mounted in the cabinet 110 may have a width of approximately 17″ and a depth of approximately 31″.

Trays 105 for each type of cabinet 110 may be of a single uniform height, so that the spacing of trays 105 in each type of cabinet 110 is uniform. This has the operational advantage of enabling trays 105 for each type of cabinet 110 to be easily interchangeable. Alternatively, trays 105 of different types may be of different heights. For example, a first type of tray 105 that supports expansion cards may be of a greater height than a second type of tray 105 that does not support expansion cards.

There are various advantages of mounting computer components on trays 105 mounted in the cabinet 110, as compared to housing computer components in a chassis mounted in a rack. Some of the advantages are described here, while other advantages are described later in this description. The design of a tray may be simpler than that of a chassis, so new tray designs supporting new groupings and placement of computer components may be generated more quickly than corresponding new chassis designs. The fabrication of a tray may also be cheaper than the fabrication of a chassis because a tray may have a simpler structure and may require less material than a chassis. Moreover, EMI testing may be simplified for trays mounted in a cabinet because EMI testing may only need to be done per cabinet, rather than per chassis.

In addition, the computer components mounted on trays 105 may be exposed so that the computer components are easily accessible after sliding a tray 105 out of the cabinet 110. In contrast, a chassis housing may cover computer components mounted in the chassis. Because a tray does not require the additional structure covering the computer components mounted on the tray, it may therefore be possible to pack trays more closely together than would otherwise be possible using chassis.

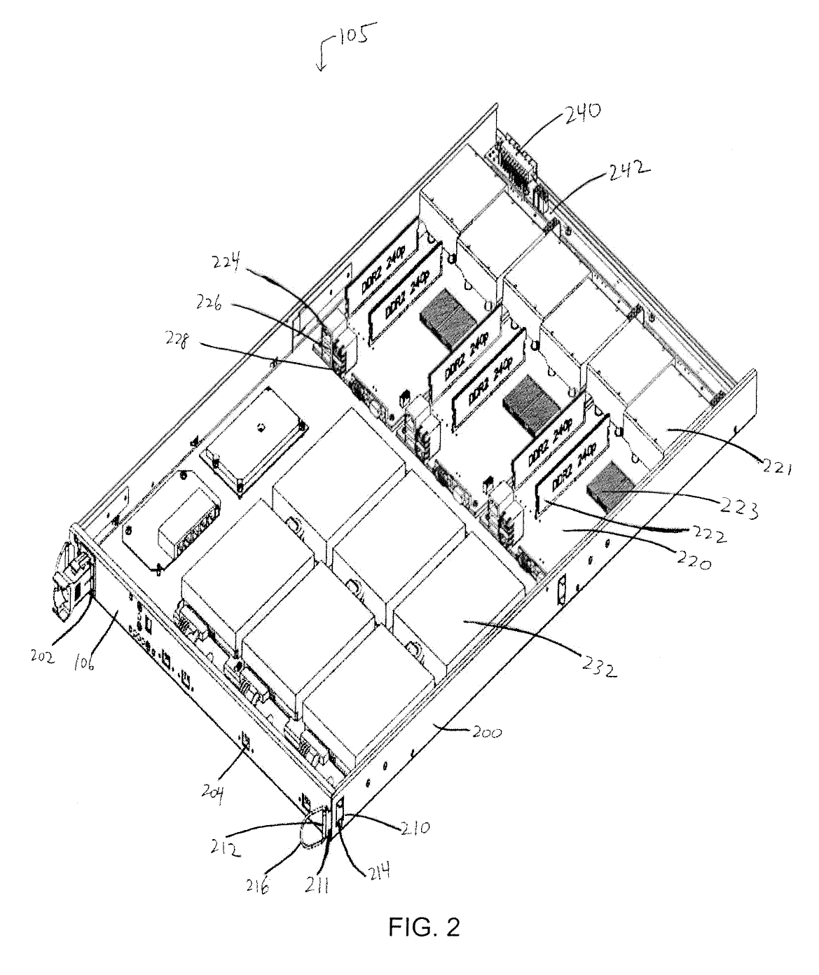

FIG. 2 illustrates a top perspective view of the tray 105 including computer components mounted thereon, in accordance with one embodiment of the present invention. The tray 105 has a front panel 106 and side panels 200. The front panel 106 includes one or more types of ports. The front panel 106 may include one or more ports 202 for electrical power. The front panel 106 may also include one or more ports 204 for network connectivity, such as Ethernet ports. In addition, the front panel 106 may include other ports that may be accessed as part of servicing or upgrading the trays 105. It is desirable for the front panel 106 to include all ports that should remain connected as the tray 105 is slid out of the cabinet 110 to facilitate servicing and/or upgrading one or more components on the tray 105 while the other components on the tray 105 remain in service. The front panel 106 may also include perforations (not shown) that allow airflow through the front panel 106. The tray 105 may have no rear panel to facilitate airflow through the tray 105.

In one embodiment, the tray 105 has mounted thereon computer components including one or more printed circuit boards (PCB) 220 and one or more hard disks 232. The configuration of the tray 105 is flexible, and other types of computer components may also be mounted on the tray 105. For example, the tray 105 may be configured as a computer server, a storage node, and/or a switch. Each PCB 220 may have mounted thereon one or more processors 221, memory 222, and a plurality of I/O connectors. Each PCB 220 may also have mounted thereon additional types of processors 223. Each PCB 220 also may have mounted thereon other types of electronic components, such as application specific integrated circuits (ASICs). The types of I/O connectors may vary depending on the configuration of the PCB 220, but may include, for example, one or more network connectors 224 (such as female RJ-45 connectors), one or more USB ports 226, and one or more video ports 228 (such as DVI connectors). The I/O connectors may further include, for example, an AT connector, a PS/2 connector, a SCSI port, an ATA port, a serial port, an IEEE 1394 port, and a parallel port.

The tray 105 may include an opening 210 in each side panel 200, and an opening 211 on each side of the front panel 106. A strip 212 is mounted on each side panel 200 using, for example, one or more screws 218. Each strip 212 faces inward toward the computer components mounted on the tray 105. Each strip 212 may be a thin piece of metal with a protrusion 214 extending from a first side of each strip 212. Each strip 212 is mounted so the protrusion 214 extends through the opening 210 in the side panel 200. Each strip 212 includes a tab 216 that protrudes from the opening 211 in the front panel 106. The strips 212 are configured to serve as part of a latching mechanism to hold each tray 105 in place in the cabinet 110, so the tray 105 does not slide in and out of the cabinet 110 without human intervention.

In one embodiment, the tray 105 may have a power connector 240 mounted on the rear portion of the tray 105. The power connector 240 may connect to a direct current (DC) power distribution bus within the cabinet 110. The power connector 240 connects the DC power distribution bus to a power interface board 242. The power interface board 242 may perform DC/DC conversion. For example, the power interface board 242 may step down the input DC voltage from 12V DC to lower DC voltages used by computer components on the tray 105.

Upon sliding the tray 105 into the cabinet 110, the power connector 240 may connect to the DC power distribution bus within the cabinet 110, so that the tray 105 powers up without any additional user action. The tray 105 may also be slid out of the cabinet 110 and remain powered up. Prior to sliding the tray 105 out of the cabinet, a power cord connected to the DC power distribution bus may be connected to the port 202 for electrical power on the front panel 106 of the tray 105. When the tray 105 slides out of the cabinet, the power connector 240 disconnects, but the power cord is sized so that it remains connected, thus powering the tray 105.

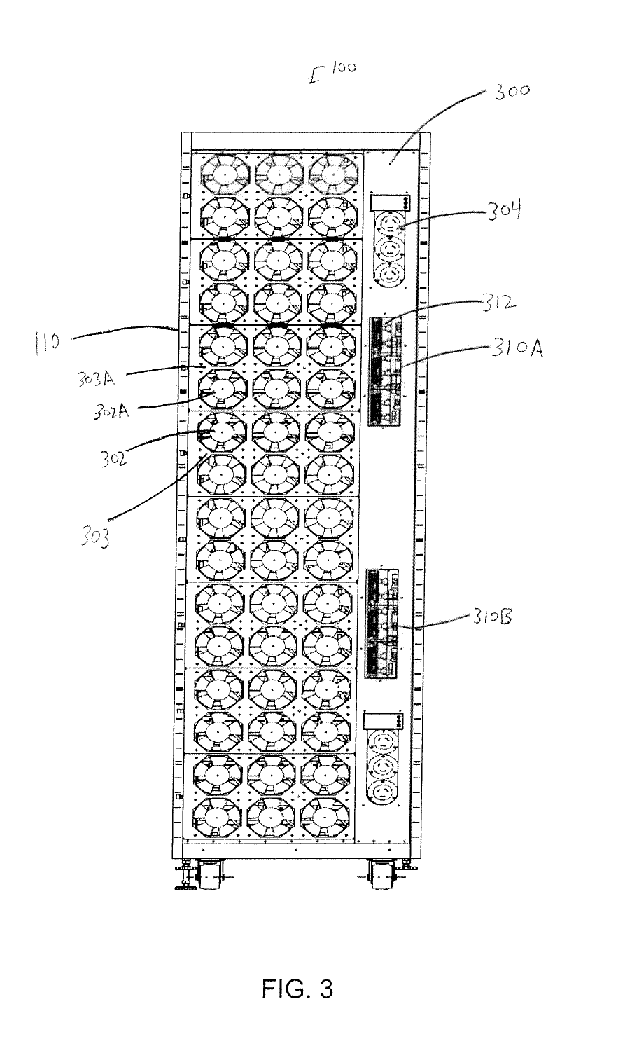

FIG. 3 illustrates a rear perspective view of the computer system 100, in accordance with one embodiment of the present invention. One or more ports 304 for electrical power may be mounted on the outside of the rear panel 300 of the cabinet 110. The outside of the rear panel 300 may also include one or more ports for network connectivity (not shown), such as Ethernet ports. Rectifier banks 310 may be mounted on the inside of the rear panel 300; portions of the rear panel 300 are cut out in FIG. 3 so that the rectifier banks 310 are visible from the outside of the cabinet 110. Each rectifier bank 310 may include multiple rectifiers 312. The rectifiers 312 may be oriented vertically, as illustrated in FIG. 3, or alternatively may be oriented horizontally.

Fans 302 may also be mounted on the rear panel 300. Alternatively, the fans 302 may be grouped in fan banks 303, and the fan banks 303 may be mounted on the rear panel 300. Each fan bank 303 may hold multiple fans 302. For example, each fan bank 303 may hold six 120 millimeter fans 302 configured in a three-by-two array, as illustrated in FIG. 3.

In one embodiment, air can be drawn out of the cabinet 110 by the fans 302. This creates a negative pressure region in the cabinet 110, such as between the trays 105, so that air travels from the environment, through perforations on the front panels 106 of the trays 105, and into the cabinet 110. In this embodiment, components on the trays 105 can be placed so, for example, components that generate the most heat are placed near the rear panel 300 where the fans 302 are located. Alternatively, fans 302 can push air from the environment into the cabinet 110, and out of the cabinet 110 through perforations on the front panels 106 of the trays 105. In this embodiment, components on the trays 105 can be placed so, for example, components that generate the most heat are placed near the front panels 106.

The fans 302 are preferably at least 4U in diameter, and can eliminate the need for fans mounted on the trays 105 or in computer components mounted on the trays 105. For example, the fans 302 may be 80 millimeters, 100 millimeters, 120 millimeters, 140 millimeters, or 160 millimeters in diameter. The increase in the size of the fans 302 as compared to the approximately 1U-diameter fans typically mounted on trays with 1U height significantly increases airflow between the trays 105 mounted in the cabinet 110, which may reduce the probability of failure of the computer components mounted on the trays 105 due to overheating. Larger fans 302 may also be more mechanically reliable than 1U fans.

In addition to providing increased airflow between the trays 105 due to their larger diameter, the fans 302 may consume less power than the corresponding number of 1U-diameter fans typically mounted on each tray. For example, there are 48 120-millimeter fans shown in FIG. 3 for cooling 40 trays. If there were 4 1U diameter fans mounted on each tray, there would be 160 1U diameter fans on the 40 trays. The combination of increased airflow and reduced power consumption may enable an increase in the density of trays 105 at a given ambient temperature, such as the temperature at the inlet to the trays 105. In addition, the combination of increased airflow and reduced power consumption may enable the density of trays 105 to be further increased by operating at an increased ambient temperature, such as 80, 85, 90, or 95 degrees Fahrenheit.

In one embodiment, the fans 302 may run at partial speed, such as 50% speed, in regular operating mode. The speed of one or more of the fans 302 may be adjusted up or down based on measurements such as temperature and/or air flow measurements at one or more locations in the cabinet 110. The failure of a fan 302A may be detected by a mechanism such as temperature and/or air flow measurements at one or more locations in the cabinet 110. In the event of such a failure, the speed of the fans 302 excluding the failed fan 302A may be adjusted up. The amount of this upward adjustment may be preconfigured and/or based on measurements such as temperature and/or air flow measurements at one or more locations in the cabinet 110. The amount of this upward adjustment may be constrained by the maximum operating speed of the fans 302. The higher speed may be maintained until the failed fan 302A is replaced.

Alternatively, the failure of a fan bank 303A may be detected by a mechanism such as temperature and/or air flow measurements at one or more locations in the cabinet 110. In the event of such a failure, the speed of the fans 302 in the other fan banks 303 may be adjusted up. The higher speed may be maintained until the failed fan bank 303A is replaced.

The placement of the fans 302 in fan banks 303 on the rear panel 300 of the cabinet 110 makes them easily replaceable and installable in the event of a failure of one of the fans 302. The fans 302 in fan banks 303 may be removed from the fan banks 303 without dismounting the fan banks 303 from the rear panel 300. It may thus be more convenient to replace fans 302 in fan banks 303 than fans that are mounted to the rear panel 300.

In addition, the use of a grid of fans 302 on the rear panel 300 limits the impact of the failure of a single fan 302A. For example, if four larger fans were to be mounted on the rear panel 300 instead of the eight fan banks 303 illustrated in FIG. 3, a failure of one of the four larger fans may result in overheating of the cabinet 110, even if the other three fans were to speed up as a result of the failure as described above. It is more likely that a failure of a single smaller fan 302A will not result in overheating of the cabinet 110, even if the other fans do not speed up as a result of the failure.

Cabinets 110 may be deployed in rows such that the rear panels 300 of the cabinets 110 face each other. This may create warm aisles between the rear panels 300 of the cabinets 110 if cooling air is exhausted from the rear panels 300, or alternatively may create warm aisles between the front sides 104 of the cabinets 110 if cooling air is exhausted from the front panels 106 of the trays 105. Alternatively, cabinets 110 may be deployed in a container with rear panels 300 facing interior walls of the container so that cooling air is exhausted into an exhaust region between the rear panels 300 and the interior walls of the container, as described in U.S. Ser. No. 11/860,685, to Coglitore et al., filed on Sep. 25, 2007, incorporated by reference herein in its entirety. The heated air may be cooled by any of a variety of known cooling systems for removing heat from air, certain embodiments of which are described in U.S. Ser. No. 11/860,685.

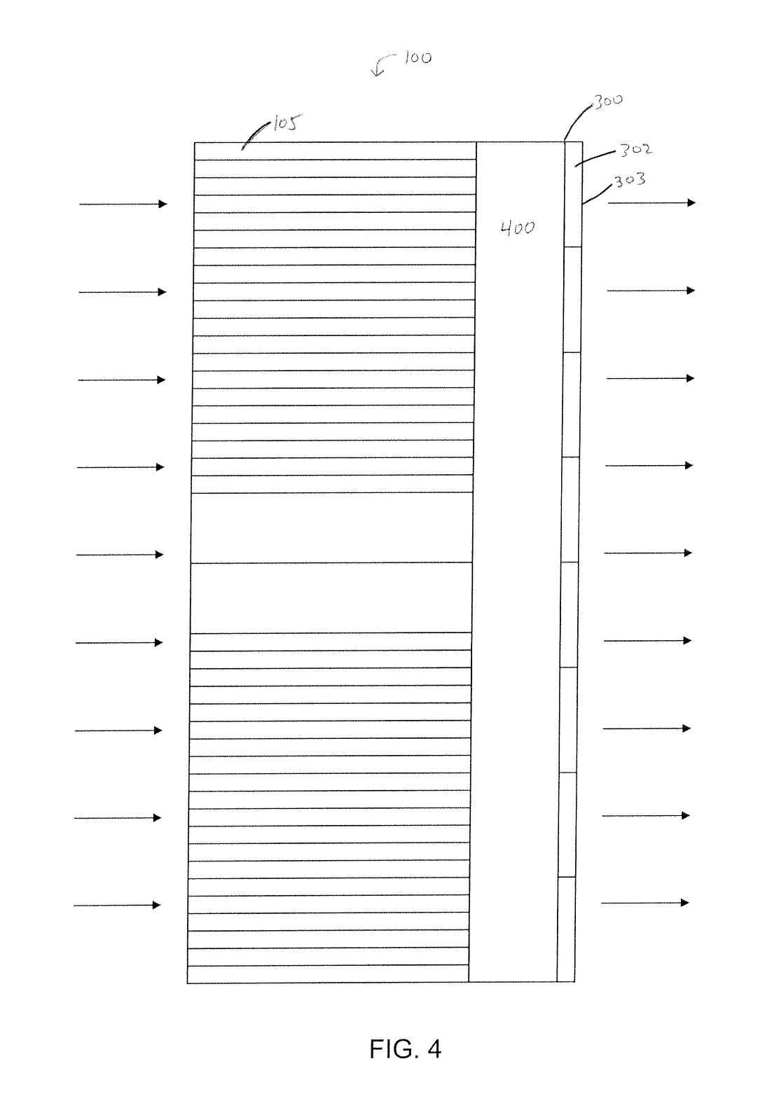

FIG. 4 illustrates a cutaway side view of the computer system 100 showing a plenum 400 located between the back of trays 105 in the cabinet 110 and the rear panel 300 of the cabinet 110 with representative airflow paths, in accordance with one embodiment of the present invention. Fans 302 may be mounted in fan banks 303 mounted on the rear panel 300. Air can be drawn out of the plenum 400 by the fans 302. This creates a negative pressure region in the plenum 400, so that air travels from the environment, through perforations on the front panels 106 of the trays 105, and into the cabinet 110. In one embodiment, the plenum 400 is approximately 12.75″ wide, measured from the back of the trays 105 to the fans 302. The purpose of the plenum 400 is to equalize air pressure across the trays so that the airflow that traverses each tray 105 becomes more uniform. Without the plenum 400, more airflow would traverse some trays 105 than others; this problem would become more severe as the size of the fans 302 becomes larger relative to the height of a tray 105.

Referring back to FIG. 2, each hard disk 232 on the tray 105 may be mounted on grommets (not shown). The grommets may be made of a compliant material such as rubber, and may aid in reducing injection of vibration into each hard disk 232. The grommets may connect into a hard disk tray (not shown) so that the hard disks 232 are held in place. In one embodiment, there is a single hard disk tray per tray 105, and multiple hard disks 232 may be mounted on the hard disk tray. In one embodiment, the injection of vibration into each hard disk 232 may also be reduced because there are no fans mounted on the trays 105.

In one embodiment, the cabinet 110 may have a DC power distribution architecture. Referring back to FIG. 3, one or more external power sources may be connected to ports 304. The external power sources may, for example, be 110V/220V AC, 208V AC sources, or 48V DC sources. If the external power source is AC, a power distribution unit (PDU) may distribute the input AC power to one or more rectifier banks 310 for conversion to DC. A DC voltage such as 12V or −48V may then be distributed to the trays 105 via a DC power distribution bus that is connected to multiple rectifiers 312 in each rectifier bank 310. Alternatively, the PDU may distribute the input AC power to the trays 105. In this case, the AC-to-DC power conversion may take place in a power supply mounted on each tray 105. If the external power source is DC, the PDU may distribute the input DC power to the trays 105.

It may be advantageous to eliminate the need for AC-to-DC conversion on each tray 105. The failure rate of the tray 105 may be reduced if no power supply (that performs AC-to-DC conversion) is present on the tray 105. In addition, if rectifiers 312 are performing AC-to-DC conversion, the heat dissipation associated with the AC-to-DC conversion is shifted to the rear portion of the cabinet 110 behind the trays 105, thus reducing the heat dissipation of components on each tray 105 and facilitating the cooling of each tray 105. Moreover, since multiple rectifiers 312 are connected to trays 105 via the DC power distribution bus, redundancy and load sharing of rectifiers 312 may be supported. For example, all of the trays 105 in the cabinet 110 may continue to operate in spite of a failure of one of the rectifiers 312. Furthermore, alternate tray configurations with larger power requirements can be supported, for example, by connecting additional rectifier banks 310 to the DC power distribution bus.

In addition, it may be advantageous to distribute 12V DC throughout the cabinet 110. For example, motherboards 220 mounted on the trays 105 may use 12V DC directly, so that no DC-to-DC step-down conversion is needed for the motherboards 220 if 12V DC is provided to the trays 105. However, traditionally 12V DC has not been distributed at a cabinet level because of the high distribution loss associated with 12V DC, and because of the high copper volumes needed for the distribution of 12V DC. These high copper volumes may significantly increase cabinet cost. Rectifier banks 310 may be positioned in the cabinet 110 to reduce the distance over which 12V DC needs to be distributed to the trays 105, and thus to decrease the volume of copper needed. For example, a first rectifier bank 310A may be positioned in the upper portion of the cabinet 110, while a second rectifier bank 310B may be positioned in the lower portion of the cabinet 110. The first rectifier bank 310A may provide a 12V DC output only to trays 105 in the upper portion of the cabinet 110, while the second rectifier bank 310B may provide a 12V DC output only to trays 105 in the lower portion of the cabinet 110. This positioning of the rectifier banks 310A and 310B may not be optimal from a cooling standpoint. Since heated air rises, it may be preferable from a cooling standpoint to position both rectifier banks 310A and 310B in the upper portion of the cabinet 110. However, a trade-off can be advantageously made to position the rectifier banks to reduce copper usage, and thus cabinet cost, while ensuring that the fans 302 still can adequately cool the trays 105.

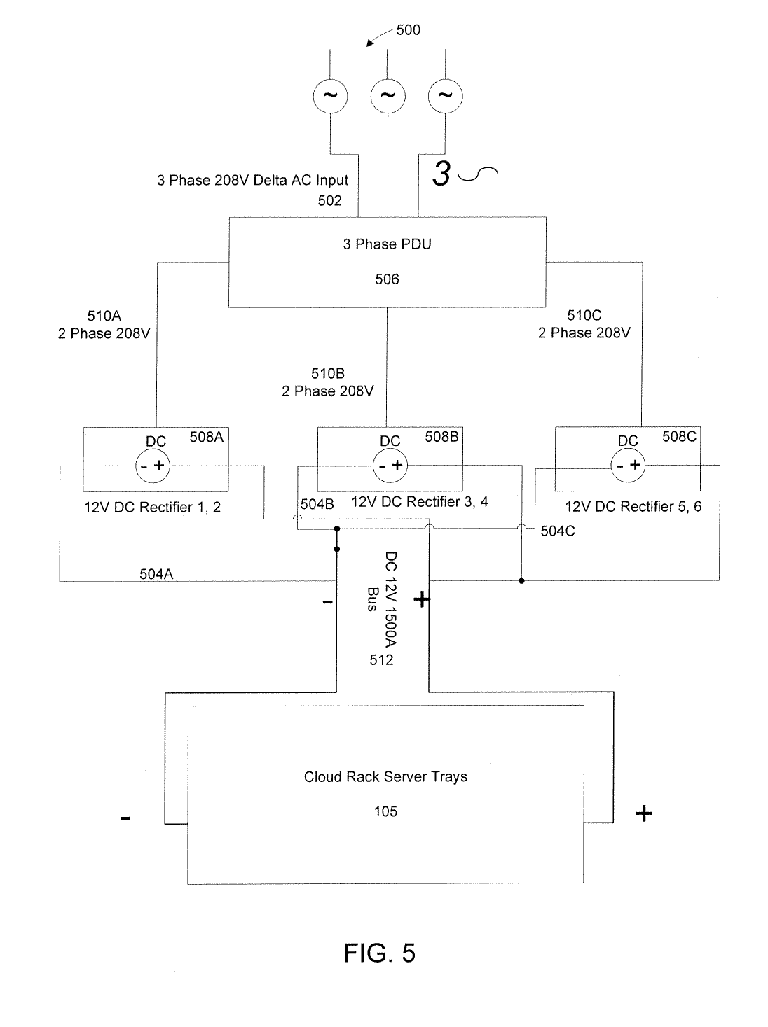

FIG. 5 illustrates a circuit 500 for converting a three-phase AC input 502 to DC outputs 504 provided to trays 105, in accordance with one embodiment of the present invention. The three-phase AC input 502 may be at 208V AC. A three-phase PDU 506 may break out the phases to the rectifiers 508. In one embodiment, the PDU 506 may provide three two-phase 208V AC outputs 510, and each rectifier 508 may convert one two-phase 208V AC input 510 to a 12V DC output 504. The 12V DC outputs 504 of the rectifiers 508 are connected to a 12V DC power distribution bus 512. The trays 105 are also connected to the power distribution bus 512, and receive DC power from the power distribution bus 512.

Alternatively, the PDU 506 may provide six single-phase AC outputs, one to each rectifier, to neutral. Each rectifier may convert one single-phase AC input to a 12V DC output. The 12V DC outputs are connected to the 12V DC power distribution bus 512 so that DC power can be distributed to the trays 105.

It may be advantageous for the cabinet 110 to include the circuit 500 to combat the stranded power problem described below. All AC power distribution in the United States, and AC power distribution in most of the world, is three-phase power. These three phases are transformed into lower working voltages in datacenters and offices, and are split apart to operate single-phase and two-phase equipment. However, since the three-phase distribution system uses the same size of wires for all three phases, each phase carries the same current rating capacity. Because power can only flow from one phase to another phase, if any single phase is loaded differently than the other two, this reduces the power available to devices on the remaining phases. This phase imbalance is a form of stranded power. Phase imbalance is a common problem due to the lack of computing equipment capable of directly accepting three-phase power. Instead, the phases are broken apart and distributed as single-phase or two-phase power. For example, a typical datacenter has cabinets with two two-phase feeds, and ten cabinets in a row. This takes seven three-phase feeds and leaves one phase on one of those feeds unconnected. Despite the best efforts of datacenter operators, a typical datacenter operates with a 10-15% phase imbalance all of the time. This corresponds to 10-15% stranded power on some of the phases, and in a large datacenter, translates into megawatts of capacity that is not utilized for servers. Balancing the phases in datacenters puts a heavy burden on facility power planners. For example, the mistake of putting more servers on one power strip than another can cause significant phase imbalances. Normal events like some servers operating under load while other servers are idle also may cause phase imbalance problems.

The cabinet 110 may use the circuit 500 to reduce this stranded power problem. Facility operators need only supply a single three-phase power input to the cabinet 110, without any need to consider phase balancing issues. The bulk rectification performed by the rectifiers 508 may allow the trays 105 to operate with constantly and significantly varying loads without any increase of phase imbalance. The rectifiers 508 employ digital control circuitry with active current sharing, allowing them to operate with a phase imbalance at or below 3.5% from 20% to 100% load. An example of the rectifiers 508 is the Emerson DS2900. This may allow the cabinet 110 to be designed with 3.5% phase imbalance at the cabinet level.

It may also be advantageous to eliminate the need for AC-to-DC conversion on each tray 105 because this may reduce the harmonic distortion created by the cabinet 110. For example, the six rectifiers 508 that may be used for AC-to-DC conversion in the cabinet 110 may generate substantially less harmonic distortion than the many tens of small power supplies that would be used in the cabinet 110 were there one or more power supplies mounted on each tray 105. For reducing harmonic distortion, it is desirable that substantially all AC power used by the cabinet 110 be converted to DC by the rectifiers 508, rather than by smaller, lower quality power supplies.

In addition, the use of the rectifiers 508 for AC-to-DC conversion in the cabinet 110 may also increase the power factor of the cabinet 110 by performing power factor correction (PFC). The below discussion provides more information related to harmonic distortion and PFC.

PFC refers to circuitry within modern power supplies to make real power and apparent power as close as possible to each other. Real power is defined as the power consumed by the device and is expressed in watts. Apparent power is the amount of power flowing through the power line to the device and is expressed in “VA”. The important difference here is that real power is what you have to pay for from the utility company as it is power you actually used, and apparent power is what you have to plan for in wiring and cabling. Some utility companies have proposed charging for VA instead of watts, which may significantly increase power costs even though actual consumption remains the same. In AC circuits, apparent power must always be greater than real power due to the physics of AC circuits. The power factor is calculated by dividing watts by VA and will always be less than 1.0 in AC circuits.

Before power factor correction, power supplies used a transformer coil to step down AC to near DC voltages, then simply rectified and regulated. These supplies had a power factor around 0.65. This means that a server consuming 300W would have to be supplied 461 VA of electricity. On a standard 208V 30A circuit loaded to 80% capacity (5000W), this means only ten servers could be connected to that circuit, even though they were only actually using 3000W. If that same server had a power factor of 0.99, the same circuit could support 16 servers, or trays 105, with a real power load of 4800W. This is one motivation for adding PFC circuitry to AC-to-DC power converters.

Today, most servers have a power factor between 0.90 and 0.95. In contrast, the cabinet 110 may use rectifiers 508, such as the Emerson DS2900, that have a power factor rating above 0.99 from 40% to 100% load and 0.995 or better above 60% load. Since power factor improves with load, and the current trend in the industry is low power servers, the right sized power supply can deliver power factors above 0.995 running a 140W server, or tray 105. This means 140.70VA on a 140W tray 105, and utilization of 99.5% of the power flowing through the AC feed cables. To return to the previous example of the common 30A 208V (80% loaded) circuit using 140W trays 105 with 0.995 power factor, up to 35 trays 105 on the line can be supported, with a real power draw of 4900W. A server or tray with the same power consumption and a power factor of 0.95 strands ten times as much power as the tray 105 with the power factor of 0.995, and translates to a loss of 2 servers or trays per circuit. This gain is based solely on high PFC and is separate from the gains of using high efficiency power supplies.

PFC has a direct bearing on total harmonic distortion (THD), where it attempts to make the load appear as if it were resistive and of only fundamental frequency. PF (displacement) has the direct benefit of appearing as efficiency on the line, when the loads limit is based on the apparent power (current) of the branch feeder, even though it has no bearing on the watts used in the data center. Similarly, phase balance will appear as an efficiency improvement to many customers as the same current limit of the highest phase limits the entire rack, row, and data center as a whole. On the other hand, THD larger than a certain level may cause distortions in the voltage waveform, which can affect other equipment receiving the voltage waveform and downstream equipment. THD may be reduced using a high quality rectifier 508, such as the Emerson DS2900, and/or using fans 302 with acceptable THD levels. Through careful design, the cabinet 110 may deliver THD values at or below 4% over its operational range, with no single harmonic order above 2% distortion. These harmonic levels are well below the requirements of the most stringent category (stage 1) of the IEC 61000-3-4, for electronic equipment over 16A.

The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A computer system, comprising:
a cabinet;
a plurality of trays located in the cabinet and having a plurality of computer components mounted thereon;
a first port mounted on a rear panel of the cabinet that receives a three-phase AC input to the cabinet;
a power distribution unit that converts the three-phase AC input to a plurality of AC signals each having fewer than three phases;
a plurality of rectifiers that convert the plurality of AC signals to DC power; and
a power distribution bus that distributes the DC power, and to which each of the plurality of rectifiers is coupled;
wherein the plurality of trays receives the DC power from the power distribution bus.

2. The computer system of claim 1, wherein the plurality of AC signals are three two-phase AC signals.

3. The computer system of claim 1, wherein the plurality of AC signals are six single-phase AC signals.

4. A computer system, comprising:
a cabinet;
a first plurality of trays located in an upper portion of the cabinet and having a first plurality of computer components mounted thereon;
a second plurality of trays located in a lower portion of the cabinet and having a second plurality of computer components mounted thereon;
a first AC-to-DC power conversion module mounted on the upper portion of the cabinet, and positioned above at least one of the first plurality of trays and below at least one of the first plurality of trays to reduce the distance over which a DC voltage output of the first AC-to-DC power conversion module is distributed to the first plurality of trays;
a second AC-to-DC power conversion module mounted on the lower portion of the cabinet, and positioned above at least one of the second plurality of trays and below at least one of the second plurality of trays to reduce the distance over which a DC voltage output of the second AC-to-DC power conversion module is distributed to the second plurality of trays;
a first DC power distribution bar coupling the first AC-to-DC power conversion module to the first plurality of trays; and
a second DC power distribution bar coupling the second AC-to-DC power conversion module to the second plurality of trays;
wherein the first plurality of trays receive DC power from the first power distribution bar, and wherein the second plurality of trays receive DC power from the second power distribution bar.

5. The computer system of claim 4, wherein the first DC power distribution bar and the second DC power distribution bar distribute 12 Volts DC.

6. The computer system of claim 5, further comprising a power interface board that converts the 12 Volts DC received from the first DC power distribution bar to lower DC voltages provided to the first plurality of trays.

7. The computer system of claim 4, further comprising:
a first port mounted on a rear panel of the cabinet that receives a three-phase AC input to the cabinet;
a power distribution unit that converts the three-phase AC input to a plurality of two-phase AC signals.

8. The computer system of claim 4, further comprising:
a first port mounted on a rear panel of the cabinet that receives a three-phase AC input to the cabinet;
a power distribution unit that converts the three-phase AC input to a plurality of single-phase AC signals.

9. The computer system of claim 4, wherein the first AC-to-DC power conversion module includes a plurality of rectifiers each having a power factor rating of at least 0.99.
